(19) United States
(12) Patent Application Publication
(10) Pub. No.: US 2018/0304541 A1
(43) Pub. Date: Oct. 25, 2018

(54) 3D LATTICE SUPPORTS FOR ADDITIVE MANUFACTURING

(71) Applicant: Carbon, Inc., Redwood City, CA (US)

(72) Inventor: Florian Markus Barth, Los Gatos, CA (US)

(21) Appl. No.: 15/938,848

(22) Filed: Mar. 28, 2018

Related U.S. Application Data
(60) Provisional application No. 62/487,238, filed on Apr. 19, 2017.

(51) Int. Cl. B29C 64/40; B29C 64/135; B33Y 10/00

(52) U.S. Cl. CPC B29C 64/40; B33Y 10/00; B29C 64/135

(57) ABSTRACT

A composite article useful in additive manufacturing typically includes: (a) optionally, but preferably, a base; (b) at least one three-dimensional lattice support connected to the base (when present); (c) at least one three-dimensional object, the object having a bottom surface portion, a top surface portion, at least one upright segment, and optionally at least one overhanging segment (e.g., a bridging segment; a cantilevered segment, etc.); (d) interconnecting supports connecting (i) each the at least one overhanging segment to the three-dimensional lattice and/or (ii) each at least one upright segment to the three-dimensional lattice; and (e) optionally, but in some embodiments preferably, a plurality of elongate stand-off supports interconnecting the bottom surface portion of each the three-dimensional object to the base.

### RELATED APPLICATIONS

This applications claims priority to U.S. Provisional Application Ser. No. 62/487,238, filed Apr. 19, 2017, the disclosure of which is hereby incorporated by reference in its entirety.

### FIELD OF THE INVENTION

The present invention concerns additive manufacturing generally, and more specifically concerns methods for manufacturing objects with dual cure resins.

### BACKGROUND

In conventional additive or three-dimensional fabrication techniques, construction of a three-dimensional object is performed in a step-wise or layer-by-layer manner. Typically, layer formation is performed through solidification of photo curable resin under the action of visible or UV light irradiation. Generally referred to as “stereolithography,” two particular techniques are known: one in which new layers are formed at the top surface of the growing object; the other in which new layers are formed at the bottom surface of the growing object. Examples of such methods include those given in U.S. Pat. No. 5,236,637 to Hull (see, e.g., FIGS. 3-4), U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and U.S. Patent Application Publication No. 2013/0295212 to Chen et al.

Recently, techniques referred to as “continuous liquid interface production” (or “CLIP”) have been developed. These techniques enable the rapid production of three- dimensional objects in a layerless manner, by which the parts may have desirable structural and mechanical properties. See, e.g., J. DeSimone et al., PCT Applications Nos. PCT/US2014/015486 (published as U.S. Pat. No. 9,211,678); PCT/US2014/015506 (published as U.S. Pat. No. 9,205,601), PCT/US2014/015497 (published as U.S. Pat. No. 9,216,546), J. Tumbleston, et al., Continuous liquid interface production of 3D Objects, Science 347, 1349-1352 (published online 16 Mar. 2015), and R. Janusziewcz et al., Layerless fabrication with continuous liquid interface production, Proc. Natl. Acad. Sci. USA 113, 11703-11708 (Oct. 18, 2016).

More recently, dual cure stereolithography resins suitable for stereolithography techniques (particularly for CLIP) are described in J. Rolland et al., U.S. Pat. No. 9,453,142, and U.S. Patent Application Publication Nos. U.S. 2016/0136889, U.S. 2016/0137838 and U.S. 2016/016077. These resins usually include a first polymerizable system typically polymerized by light (sometimes referred to as “Part A”) from which an intermediate object is produced, and also include at least a second polymerizable system (“Part B”) which is usually cured after the intermediate object is first formed, and which impart desirable structural and/or tensile properties to the final object.

These two developments have spurred the application of additive manufacturing processes beyond the manufacture of (primarily) prototype objects, to functional objects more suited to a variety of end uses. This, however, has created a variety of new technical problems requiring solution. For example, an intermediate object made by additive manufacturing from a dual cure resin may need to be packed in a supporting material such as a particulate for subsequent heat cure so that it does not warp or distort during the subsequent heat cure. See, e.g., Xinyu Gu et al., PCT Application WO 2017/040890 (published Mar. 9, 2017). While satisfactory for some situations, in other situations it would be preferable to eliminate the need to provide an additional material for supporting intermediate objects during the cure step.

### SUMMARY

A composite article useful in additive manufacturing is described. The composite article is typically a green intermediate produced by light polymerization of a dual cure resin in an additive manufacturing process. The composite article typically includes: (a) optionally, but preferably, a base; (b) at least one three-dimensional lattice support connected to the base (when present); (c) at least one three-dimensional object, the object having a bottom surface portion, a top surface portion, at least one upright segment, and optionally at least one overhanging segment (e.g., a bridging segment; a cantilevered segment, etc.); (d) interconnecting supports connecting (i) each the at least one overhanging segment to the three-dimensional lattice and/or (ii) each at least one upright segment to the three-dimensional lattice; and (e) optionally, but in some embodiments preferably, a plurality of elongate stand-off supports interconnecting the bottom surface portion of each the three-dimensional object to the base.

In some embodiments, base is present (e.g., and comprises a thin planar segment, optionally but preferably configured to promote adhesion of the composite article to an additive manufacturing carrier plate).

In some embodiments, the stand-off supports are present.

In some embodiments, a three-dimensional lattice support and the interconnecting supports are configured to inhibit distortion of the at least one three-dimensional object during subsequent heating of the composite article (e.g., in a subsequent heat curing step for an article formed from a dual cure resin).

In some embodiments, the at least one three-dimensional object comprises a plurality of separate and distinct three-dimensional objects, all connected to the same the three-dimensional lattice by the interconnecting supports (the composite article preferably configured to be more rigid than a like article comprising only one three-dimensional object).

In some embodiments, the additive manufacturing process comprises stereolithography (e.g., bottom-up stereolithography).

In some embodiments, the additive manufacturing process comprises continuous liquid interface production.

In some embodiments, the base is adhered to an additive manufacturing carrier plate, and optionally wherein the base has at least one resin flow opening formed therein, the resin flow opening configured to promote flow of resin into the composite article during additive manufacturing thereof, and/or configured to promote flow of wash liquid into and out of the composite article during washing thereof.

In some embodiments, the lattice support is configured to promote flow of resin into the composite article during additive manufacturing thereof, and/or configured to promote flow of wash liquid into and out of the composite article during washing thereof.

In some embodiments, the lattice support has at least one enlarged channel formed therein, the enlarged channel configured to further promote flow of resin into the composite article during additive manufacturing thereof, and/or configured to further promote flow of wash liquid into and out of the composite article during washing thereof.

In some embodiments, (i) the composite article is more flexible than the same article following subsequent cure (e.g., heat cure); or (ii) the composite article is less flexible than the same article following subsequent cure (e.g., heat cure) thereof).

In some embodiments, the dual cure resin is comprised of: (i) light-polymerizable monomers and/or prepolymers that can participate in forming an intermediate object by stereolithography (preferably included in an amount of from 5, 10, or 20 percent by weight, to 50, 60, or 80 percent by weight); (ii) heat-polymerizable monomers and/or prepolymers (preferably included in an amount of from 5, 10 or 20 percent by weight, to 40, 50 or 60 percent by weight).

In some embodiments, (iii) the light-polymerizable monomers and/or prepolymers comprise reactive end groups selected from acrylates, methacrylates, α-olefins, N-vinyls, acrylamides, methacrylamides, styrenics, epoxides, thiols, 1,3-dienes, vinyl halides, acrylonitriles, vinyl esters, maleimides, and vinyl ethers; and/or (iv) the heat-polymerizable monomers and/or prepolymers comprise reactive end groups selected from: epoxy/amine, epoxy/hydroxyl, oxetane/amine, oxetane/alcohol, isocyanate/hydroxyl, isocyanate/amine, isocyanate/carboxylic acid, cyanate ester, anhydride/amine, amine/carboxylic acid, amine/ester, hydroxyl/carboxylic acid, hydroxyl/acid chloride, amine/acid chloride, vinyl/Si-H, Si-Cl/hydroxyl, Si-Cl/amine, hydroxyl/aldehyde, amine/aldehyde, hydroxymethyl or alkoxymethyl amide/alcohol, aminoplast, alkyne/azide, click chemistry reactive groups, alkene/sulfur, alkene/thiol, alkyne/thiol, hydroxyl/halide, isocyanate/water, Si-OH/hydroxyl, Si-OH/water, Si-OH/Si-H, Si-OH/Si-OH, perfluorovinyl, diene/dienophiles, olefin metathesis polymerization groups, olefin polymerization groups for Ziegler-Natta catalysis, and ring-opening polymerization groups, and mixtures thereof.

In some embodiments, the dual cure resin comprises a light-polymerizable component that degrades upon heating and forms a reactant in heat curing thereof.

In some embodiments, a method of making at least one object includes the steps of: (a) providing a composite article as described herein; (b) optionally, but in some embodiments preferably, washing the object (e.g., with a wash liquid comprising an organic solvent); then (c) further curing the composite article; and then (d) separating each the object from the interconnecting supports, and from the stand-off supports if present, to produce the at least one object.

In some embodiments, the further curing step is carried out by heating (e.g., by directly contacting the composite article to a heated gas, such as heated air, in an oven such as a convection oven).

In some embodiments, the wash step is included and is carried out by immersing the composite article in a wash liquid, with agitation (e.g., by rotating the composite article in the wash liquid), optionally but preferably wherein the wash step is carried out in a time of 10 minutes or less.

In some embodiments the further curing step either: (i) increases the flexibility of the composite article, or (ii) decreases the flexibility of the composite article.

In some embodiments, the further curing step is carried out under conditions in which the least one object is made less frangible than the interconnecting supports.

In some embodiments, the further curing step is carried out under conditions in which the three-dimensional lattice support is made less frangible than the interconnecting supports.

A further aspect of the invention is a method of making at least one object, comprising the steps of: (a) providing a composite article as described herein; (b) optionally, but in some embodiments preferably, washing the object (e.g., with a wash liquid comprising an organic solvent); then (c) further curing the composite article (e.g., by heating); and then (d) separating each the object from the interconnecting supports, and from the stand-off supports if present, to produce the at least one object.

3D lattice supports have been described for use in making objects by stereolithography from conventional resins (see, e.g., Materialise e-Stage™ automated support generation software), but such supports have not heretofore been suggested for use during further curing (e.g., baking) of an intermediate object produced from a dual cure resin.

Utility. The 3D lattice backbone structure with interconnecting supports applied to production geometry as described herein increases structural rigidity and improves the production process. While illustrated primarily with dental mouth guards herein, this invention can be used with a variety of part geometries, including applications in consumer electronic parts, components, cases and housings, medical devices, automotive and aerospace parts and components, footwear components, etc. Specifically, the invention can be used in supporting objects including dental trays and dental aligners, eye-wear frames, and surgical guides.

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1 is a perspective view of a first embodiment of a composite article of the present invention.

FIG. 2 is an exploded view of the embodiment of FIG. 1.

FIG. 3 is a detailed view of the portion of the embodiment of FIG. 1 contained in the dashed square in FIG. 1.

FIG. 4 is a perspective view of a second embodiment of a three-dimensional lattice support useful in the present invention.

FIG. 5 is a perspective view of a third embodiment of a three-dimensional lattice support useful in the present invention.

FIG. 6 is a perspective view of an alternate embodiment of a composite article of the present invention, where a plurality of objects are mounted on the three dimensional lattice of FIG. 5.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

As used herein, the term “and/or” includes any and all possible combinations or one or more of the associated listed items, as well as the lack of combinations when interpreted in the alternative (“or”).
1. Resins and Dual Cure Resins.

While the present invention can be implemented with any suitable polymerizable liquid (particularly light-polymerizable liquids as used in stereolithography), dual cure resins are currently preferred.

Dual cure polymerizable liquids useful in additive manufacturing, particularly for stereolithogrpahy techniques such as continuous liquid interface production (CLIP) are known and described in, for example, J. Rolland et al., PCT Applications PCT/US2015/036893 (see also U.S. Patent Application Pub. No. US 2016/0136889), PCT/US2015/036902 (see also U.S. Patent Application Pub. No. US 2016/0137838), PCT/US2015/036924 (see also U.S. Patent Application Pub. No. US 2016/016077), and PCT/US2015/036946 (see also U.S. Pat. No. 9,453,142). In general, such resins can comprise: (a) light-polymerizable monomers and/or prepolymers that can form an intermediate object (typically in the presence of a photocatalyst); and (b) heat-polymerizable monomers and/or prepolymers. Each of these constituents is discussed further below.

A. Light polymerizable monomers and/or prepolymers. Sometimes also referred to as “Part A” of the resin, these are monomers and/or prepolymers that can be polymerized by exposure to actinic radiation or light. This resin can have a functionality of 2 or higher (though a resin with a functionality of 1 can also be used when the polymer does not dissolve in its monomer). A purpose of Part A is to “lock” the shape of the object being formed or create a scaffold for the one or more additional components (e.g., Part B). Importantly, Part A is present at or above the minimum quantity needed to maintain the shape of the object being formed after the initial solidification during photolithography. In some embodiments, this amount corresponds to less than ten, twenty, or thirty percent by weight of the total resin (polymerizable liquid) composition.

Examples of suitable reactive end groups suitable for Part A constituents, monomers, or prepolymers include, but are not limited to: acrylates, methacrylates, α-olefins, N-vinyls, acrylamides, methacrylamides, styrenics, epoxides, thiols, 1,3-dienes, vinyl halides, acrylonitriles, vinyl esters, maleimides, and vinyl ethers.

An aspect of the solidification of Part A is that it provides a scaffold in which a second reactive resin component, termed “Part B,” can solidify during a second step, as discussed further below.

B. Heat-polymerizable monomers and/or prepolymers. Sometimes also referred to as “Part B”, these constituents may comprise, consist of or consist essentially of a mix of monomers and/or prepolymers that possess reactive end groups that participate in a second solidification reaction after the Part A solidification reaction. In general, for dual cure resins, examples of methods used to solidify Part B include, but are not limited to, contacting the object or scaffold to heat, water or water vapor, light at a different wavelength than that at which Part A is cured, catalysts, (with or without additional heat), evaporation of a solvent from the polymerizable liquid (e.g., using heat, vacuum, or a combination thereof), microwave irradiation, etc., including combinations thereof. In this case, heat curing of the “Part B” resins is preferred.

Examples of suitable reactive end group pairs suitable for Part B constituents, monomers or prepolymers include, but are not limited to: epoxy/amine, epoxy/hydroxyl, oxetane/amine, oxetane/alcohol, isocyanate*/hydroxyl, Isocyanate*/amine, isocyanate/carboxylic acid, anhydride/amine, amine/carboxylic acid, amine/ester, hydroxyl/carboxylic acid, hydroxyl/acid chloride, amine/acid chloride, vinyl/Si-H (hydrosilylation), Si-Cl/hydroxyl, Si-Cl/amine, hydroxyl/aldehyde, amine/aldehyde, hydroxymethyl or alkoxymethyl amide/alcohol, aminoplast, alkyne/Azide (also known as one embodiment of “Click Chemistry,” along with additional reactions including thiolene, Michael additions, Diels-Alder reactions, nucleophilic substitution reactions, etc.), alkene/Sulfur (polybutadiene vulcanization), alkene/peroxide, alkene/thiol, alkyne/thiol, hydroxyl/halide, isocyanate*/water (polyurethane foams), Si-OH/hydroxyl, Si-OH/water, Si-OH/Si-H (tin catalyzed silicone), Si-OH/Si-OH (tin catalyzed silicone), Perfluorovinyl (coupling to form perfluorocyclobutane), etc., where *Isocyanates include protected isocyanates (e.g. oximes)), diene/dienophiles for Diels-Alder reactions, olefin metathesis polymerization, olefin polymerization using Ziegler-Natta catalysis, ring-opening polymerization (including ring-opening olefin metathesis polymerization, lactams, lactones, Siloxanes, epoxides, cyclic ethers, imines, cyclic acetals, etc.), etc. As will be noted from the above, the “Part B” components generally comprise at least a pair of compounds, reactive with one another (e.g., a polyisocyanate, and a polyamine).

C. Thermoplastic particles. Thermoplastic polymer particles as used herein are those that are not initially soluble in the polymerizable liquid, but can be dispersed in the liquid below the dissolution temperature thereof. “Insoluble” as used herein refers to both completely insoluble polymer particles, and poorly soluble particles which dissolve so slowly that they can be dispersed in the resin without dissolving to such an extent that they cannot be light polymerized as particles in the resin during production of a three dimensional intermediate. Thus, the particles may be initially dispersed rather than dissolved for any reason, including but not limited to inherently immiscibility/insolubility, Upper Critical Solution Temperature (UCST), crystallization, encapsulation in a shell which melts/degrades at high temperatures (e.g., wax melt, crystal melt, hydrogen bonding, degradation at high temperature, etc.).

Optionally, but in some embodiments preferably, the thermoplastic polymer from which the particles are formed may include terminal function or reactive groups. Suitable functional or reactive groups include, but are not limited to, amine, phenol, maleimide, and carboxyl groups. Such reactive groups may be included for any of a variety of purposes, including but not limited to promoting compatibility and adhesion between matrices, such as: the first and second curable components of the dual cure system, and the thermoplastics, may react with thermosettable component or UV curable component to form stable linkages, may react with thermosettable components or UV curable component transiently, to control domain size and morphology of phase-separated thermoplastic, may catalyze cure of thermosettable components, acting as a latent catalyst (especially amine-terminated with epoxy and cyanate ester), etc.

In general, the thermoplastic particles have an average diameter of from 0.5 to 10, 20, or 50 microns. They may be prepared from a then isoplastic polymer by any suitable technique, including but not limited to mechanical grinding, cryo milling, spray drying, coagulation, etc., along with sieving or other techniques known to those skilled in the art.

D. Additional resin ingredients. Photoinitiators included in the polymerizable liquid (resin) can be any suitable photoiniator, including type I and type II photoinitiators and including commonly used UV photoinitiators, examples of which include but are not limited to such as acetophenones (diethoxyacetophenone for example), phosphine oxides diphenyl(2,4,6-trimethylbenzoyl)phosphine oxide, phenylbis(2,4,6-trimethylbenzoyl) phosphine oxide (PPO), Irgacure 369, etc. See, e.g., U.S. Pat. No. 9,453,142 to Rolland et al.

The liquid resin or polymerizable material can have solid particles suspended or dispersed therein. Any suitable solid particle can be used, depending upon the end product being fabricated. The particles can be metallic, organic/polymeric, inorganic, or composites or mixtures thereof. The particles can be nonconductive, semi-conductive, or conductive (including metallic and non-metallic or polymer conductors); and the particles can be magnetic, ferromagnetic, paramagnetic, or nonmagnetic. The particles can be of any suitable shape, including spherical, elliptical, cylindrical, etc. The particles can be of any suitable size (for example, ranging from 1 nm to 20 um average diameter).

The particles can comprise an active agent or detectable compound as described below, though these may also be provided dissolved solubilized in the liquid resin as also discussed below. For example, magnetic or paramagnetic particles or nanoparticles can be employed.

The liquid resin can have additional ingredients solubilized therein, including pigments, dyes, active compounds or pharmaceutical compounds, detectable compounds (e.g., fluorescent, phosphorescent, radioactive), etc., again depending upon the particular purpose of the product being fabricated. Examples of such additional ingredients include, but are not limited to, proteins, peptides, nucleic acids (DNA, RNA) such as siRNA, sugars, small organic compounds (drugs and drug-like compounds), etc., including combinations thereof.

Hardeners: Additional components (hardeners) can be used which react with the liberated maleimide. Any suitable hardener may be used (see, e.g., U.S. Pat. Nos. 5,599,856; 6,656,979; 8,632,654; and 9,3115,698). In some embodiments, the hardener comprises an amine or polyamine (e.g., an aromatic amine or polyamine, a cycloaliphatic amine or polyamine, an aliphatic amine or polyamine such as a polyether amine, etc.).

In some embodiments, the hardener comprises a thiol or polythiol, an allyl or polyallyl (diallyls, triallyls); a maleimide (including but not limited to those described herein above and below); a vinyl ether, etc.

Particular examples of suitable thiol hardeners include, but are not limited to, 4,4′-dimercaptodiphenylether, 4,4′-dimercaptobiphenyl, trimethylolpropane tris(3-mercaptopropionate), pentaerythritol tetrakis(3-mercaptopropionate), 1,3,5-tris(3-mercaptopropyl)-1,3,5-triazine-2,4,6-trione, etc.

Examples of suitable allyls include, but are not limited to, allyl (meth)acrylate, 2,2′-diallylbisphenol A and triallyl-1,3,5-triazine-2,4,6-(1H,3H,5H)-trione.

In some embodiments, the hardener comprises a latent hardener (including mixtures thereof): That is, a hardener having a low reactivity at lower temperatures, and/or which is sparingly soluble at lower temperatures, such that the hardener can be more stable at room temperature, but then activated upon heating. Numerous examples of latent hardeners are known (See, e.g., U.S. Pat. No. 8,779,036; see also U.S. Pat. No. 4,859,761). Particular examples include substituted guanidines and aromatic amines, such as dicyandiamide, benzoguanamine, o-tolylbiguanidine, bis(4-aminophenyl) sulfone (also known as diamino diphenylsulfone: DDS), bis(3-aminophenyl) sulfone, 4,4′-methylenediamine, 1,2- or 1,3- or 1,4-benzenediamines, bis(4-aminophenyl)-1,4-diisopropylbenzene (e.g. EPON 1061 from Shell), bis(4-amino-3,5-dimethylphenyl)-1,4-diisopropylbenzene (e.g. EPON 1062 from Shell), bis(aminophenyl) ether, diaminobenzophenones, 2,6-diaminopyridine, 2,4-toluenediamine, diaminodiphenylpropanes, 1,5-diaminonaphthalene, xylenediamines, 1,1-bis-4-aminophenylcyclohexane, methylenebis(2,6-diethylaniline) (e.g. LONZACURE M-DEA from Lonza), methylenebis(2-isopropyl-6-methylaniline) (e.g. LONZACURE M-MIPA from Lonza), methylenebis(2,6-diisopropylaniline) (e.g. LONZACURE M-DIPA from Lonza), 4-aminodiphenylamine, diethyltoluenediamine, phenyl-4,6-diaminotriazine, and lauryl-4,6-diaminotriazine. Still other examples include N-acylimidazoles such as 1-(2′,4′,6′-trimethylbenzoyl)-2-phenylimidazole or 1-benzoyl-2-isopropylimidazole (see, e.g., U.S. Pat. Nos. 4,436,892 and 4,587,311); Cyanoacetyl compounds such as neopentyl glycol biscyanoacetate, N-isobutylcyanoacetamide, 1,6-hexamethylene biscyanoacetate or 1,4-cyclohexanedimethanol biscyanoacetate (see, e.g., U.S. Pat. No. 4,283,520); N-cyanoacylamide compounds such as N,N′-dicyanoadipic diamide (see, e.g., U.S. Pat. Nos. 4,529,821, 4,550,203, and 4,618,712; acylthiopropylphenols (see, e.g., U.S. Pat. No. 4,694,096) and the urea derivatives such as toluene-2,4-bis(N,N-dimethylcarbamide) (see, e.g., U.S. Pat. No. 3,386,955); and aliphatic or cycloaliphatic diamines and polyamines if they are sufficiently unreactive. An example which may be mentioned here is polyetheramines, e.g. JEFFAMINE 230 and 400. Aliphatic or cycloaliphatic diamines or polyamines whose reactivity has been reduced by steric and/or electronic influencing factors or/and are sparingly soluble or have a high melting point, e.g. JEFFLINK 754 (Huntsman) or CLEARLINK 1000 (Dorf Ketal) can also be used.

Dyes/non-reactive light absorbers. In some embodiments, polymerizable liquids for carrying out the present invention include a non-reactive pigment or dye that absorbs light, particularly UV light. Suitable examples of such light absorbers include, but are not limited to: (i) titanium dioxide (e.g., included in an amount of from 0.05 or 0.1 to 1 or 5 percent by weight), (ii) carbon black (e.g., included in an amount of from 0.05 or 0.1 to 1 or 5 percent by weight), and/or (iii) an organic ultraviolet light absorber such as a hydroxybenzophenone, hydroxyphenylbenzotriazole, oxanilide, benzophenone, thioxanthone, hydroxypenyltriazine, and/or benzotriazole ultraviolet light absorber (e.g., Mayzo BLS1326) (e.g., included in an amount of 0.001 or 0.005 to 1, 2 or 4 percent by weight). Examples of suitable organic ultraviolet light absorbers include, but are not limited to, those described in U.S. Pat. Nos. 3,213,058; 6,916,867; 7,157,586; and 7,695,643, the disclosures of which are incorporated herein by reference.

Fillers. Any suitable filler may be used in connection with the present invention, depending on the properties desired in the part or object to be made. Thus, fillers may be solid or liquid, organic or inorganic, and may include reactive and non-reactive rubbers: siloxanes, acrylonitrile-butadiene rubbers; reactive and non-reactive thermoplastics (including but not limited to: poly(ether imides), maleimide-styrene terpolymers, polyarylates, polysulfones and polyethersulfones, etc.) inorganic fillers such as silicates (such as talc, clays, silica, mica), glass, carbon nanotubes, graphene, cellulose nanocrystals, etc., including combinations of all of the foregoing. Suitable fillers include tougheners, such as core-shell rubbers, as discussed below.

Tougheners. One or more polymeric and/or inorganic tougheners can be used as a filler in the present invention. See generally U.S. Patent Application Publication No. 20150215430. The toughener may be uniformly distributed in the form of particles in the cured product. The particles could be less than 5 microns (um) in diameter. Such tougheners include, but are not limited to, those formed from elastomers, branched polymers, hyperbranched polymers, dendrimers, rubbery polymers, rubbery copolymers, block copolymers, core-shell particles, oxides or inorganic materials such as clay, polyhedral oligomeric silsesquioxanes (POSS), carbonaceous materials (e.g., carbon black, carbon nanotubes, carbon nanofibers, fullerenes), ceramics and silicon carbides, with or without surface modification or functionalization.

Core-shell rubbers. Core-shell rubbers are particulate materials (particles) having a rubbery core. Such materials are known and described in, for example, U.S. Patent Application Publication No. 20150184039, as well as U.S. Patent Application Publication No. 20150240113, and U.S. Pat. Nos. 6,861,475, 7,625,977, 7,642,316, 8,088,245, and elsewhere. In some embodiments, the core-shell rubber particles are nanoparticles (i.e., having an average particle size of less than 1000 nanometers (nm)). Generally, the average particle size of the core-shell rubber nanoparticles is less than 500 nm, e.g., less than 300 nm, less than 200 nm, less than 100 nm, or even less than 50 nm. Typically, such particles are spherical, so the particle size is the diameter; however, if the particles are not spherical, the particle size is defined as the longest dimension of the particle. Suitable core-shell rubbers include, but are not limited to, those sold by Kaneka Corporation under the designation Kaneka Kane Ace, including the Kaneka Kane Ace 15 and 120 series of products, including Kanaka Kance Ace MX 120, Kaneka Kane Ace MX 153, Kaneka Kane Ace MX 154, Kaneka Kane Ace MX 156, Kaneka Kane Ace MX170, and Kaneka Kane Ace MX 257 and Kaneka Kane Ace MX 120 core-shell rubber dispersions, and mixtures thereof.

In some embodiments, the dual cure resin can be a Carbon, Inc. rigid polyurethane resin (RPU), flexible polyurethane resin (FPU), elastomeric polyurethane resin (EPU), epoxy resin (EPX) or cyanate ester resin (CE), all available from Carbon, Inc., 1089 Mills Way, Redwood City, Calif. 94063 USA.

Note that dual cure resins may be partial, or complete. In a complete resin, all constituents for both cure steps are included in the resin for the initial light polymerization step. In a partial dual cure resin, some constituents for the second cure may be reduced in amount or missing entirely, but then the intermediate or “green” part, after initial production by additive manufacturing, contacted with a penetrant liquid, with the penetrant liquid carrying a further constituent of the dual cure system, such as a reactive monomer, into the part for participation in a subsequent cure.

2. ADDITIVE MANUFACTURING METHODS AND APPARATUS.

The intermediate object is preferably formed from polymerizable resins by additive manufacturing, typically bottom-up additive manufacturing, generally known as stereolithography. Such methods are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication Nos. 2013/0292862 to Joyce, and U.S. Patent Application Publication No. 2013/0295212 to Chen et al. Such techniques typically involve projecting light through a window above which a pool of resin (or polymerizable liquid) is carried. A general purpose or functional part carrier is typically positioned above the window and above the pool, on which the growing object is produced.

In some embodiments of the present invention, the intermediate object is formed by continuous liquid interface production (CLIP). CLIP is known and described in, for example, PCT Applications Nos. PCT/US2014/015486 (published as U.S. Pat. No. 9,211,678 on Dec. 15, 2015); PCT/US2014/015506 (also published as U.S. Pat. No. 9,205,601 on Dec. 8, 2015), PCT/US2014/015497 (also published as U.S. Pat. No. 9,216,546 on Dec. 22, 2015), and in J. Tumbleston, D. Shirvanyants, N. Ermoshkin et al., Continuous liquid interface production of 3D Objects, Science 347, 1349-1352 (published online 16 Mar. 2015). See also R. Janusziewcz et al., Layerless fabrication with continuous liquid interface production, Proc. Natl. Acad. Sci. USA 113, 11703-11708 (Oct. 18, 2016). In some embodiments, CLIP employs features of a bottom-up three dimensional fabrication as described above, but the irradiating and/or the advancing steps are carried out while also concurrently maintaining a stable or persistent liquid interface between the growing object and the build surface or window, such as by: (i) continuously maintaining a dead zone of polymerizable liquid in contact with the build surface, and (ii) continuously maintaining a gradient of polymerization zone (such as an active surface) between the dead zone and the solid polymer and in contact with each thereof, the gradient of polymerization zone comprising the first component in partially cured form.

In some embodiments of CLIP, the optically transparent member comprises a semipermeable member (e.g., a fluoropolymer), and the continuously maintaining a dead zone is carried out by feeding an inhibitor of polymerization through the optically transparent member, thereby creating a gradient of inhibitor in the dead zone and optionally in at least a portion of the gradient of polymerization zone. Other approaches for carrying out CLIP that can be used in the present invention and potentially obviate the need for a semipermeable “window” or window structure include utilizing a liquid interface comprising an immiscible liquid (see L. Robeson et al., WO 2015/164234, published Oct. 29, 2015), generating oxygen as an inhibitor by electrolysis (see I. Craven et al., WO 2016/133759, published Aug. 25, 2016), and incorporating magnetically positionable particles to which the photoactivator is coupled into the polymerizable liquid (see J. Rolland, WO 2016/145182, published Sep. 15, 2016).

In some embodiments, the additive manufacturing apparatus can be a Carbon, Inc. M1 or M2 apparatus implementing continuous liquid interface production, available from Carbon, Inc., 1089 Mills Way, Redwood City, Calif. 94063 USA.

3. ADDITIVE MANUFACTURING WITH 3D LATTICE SUPPORTS.

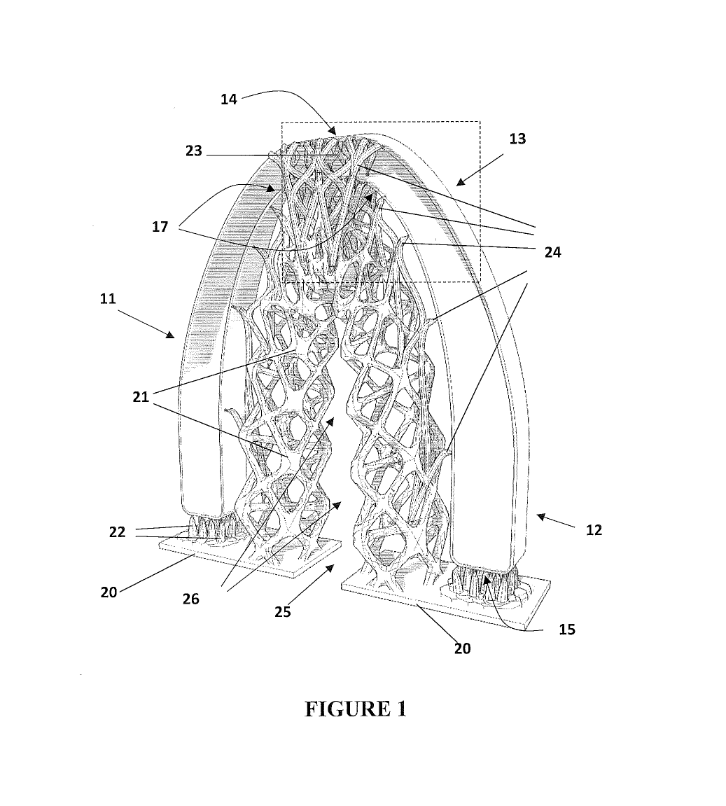

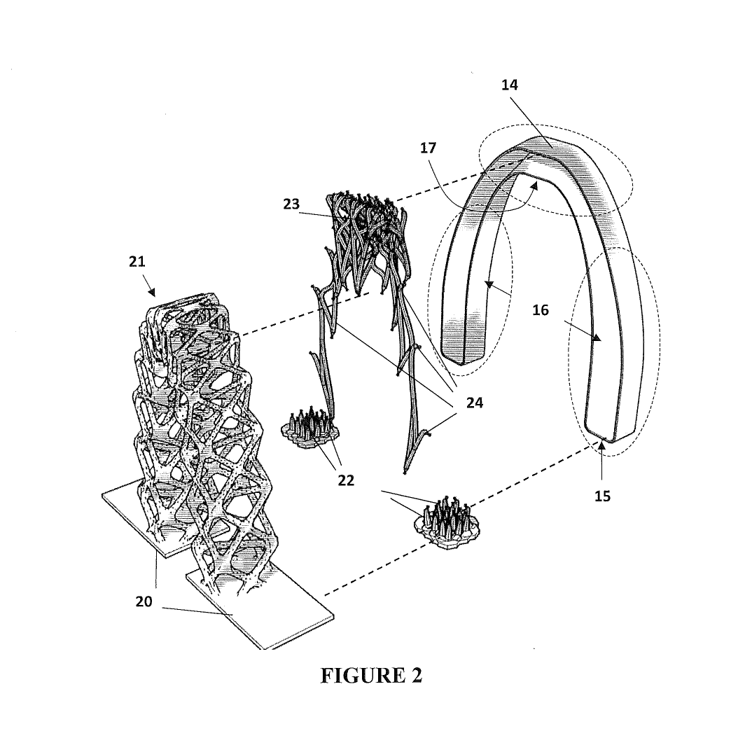

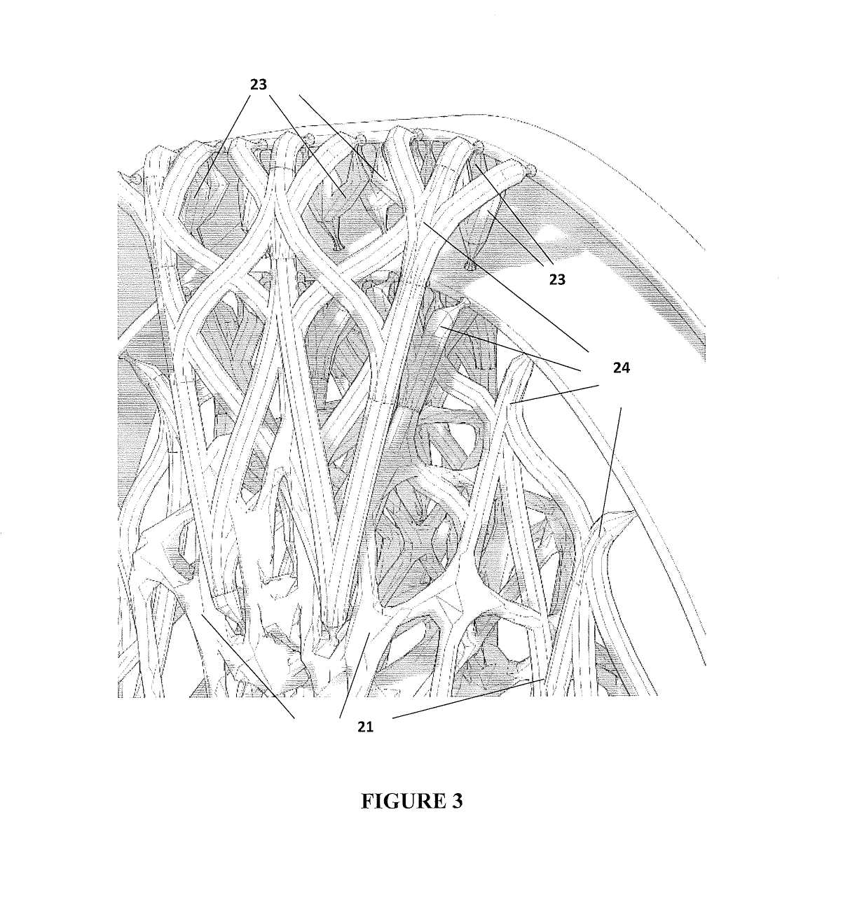

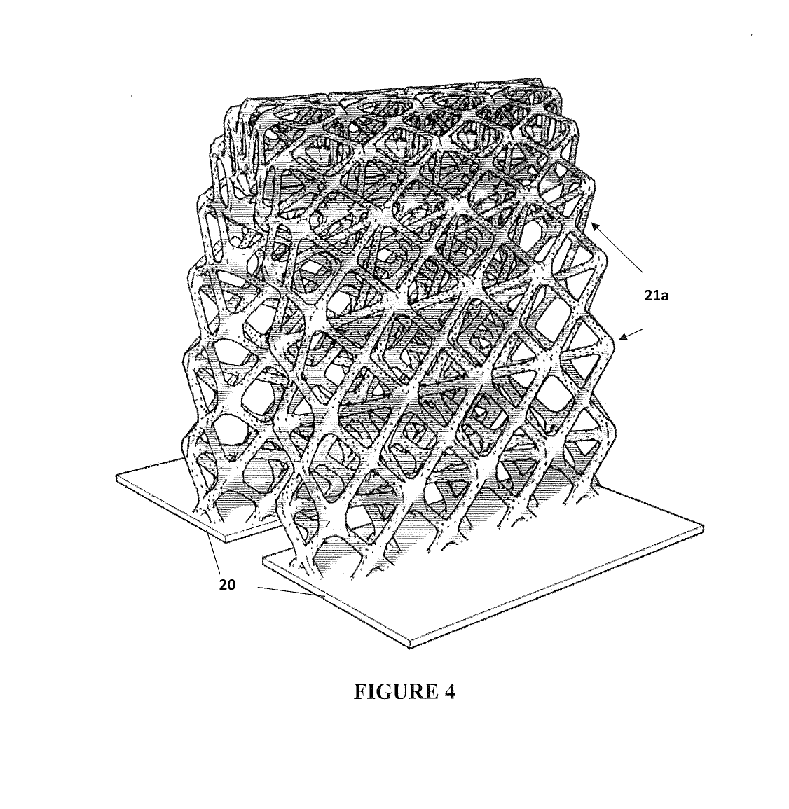

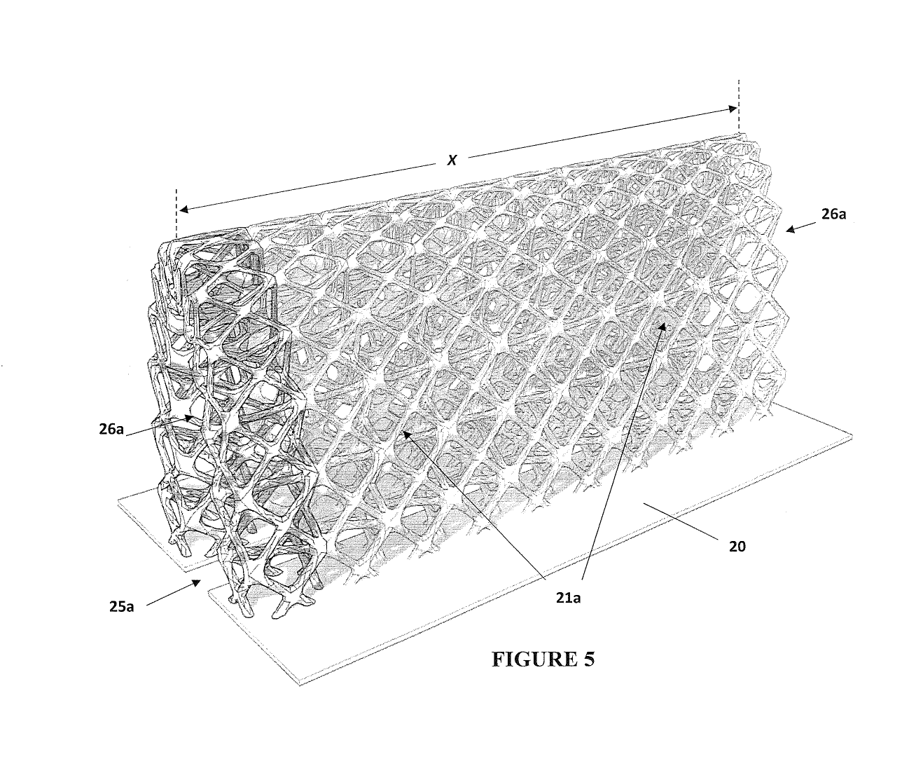

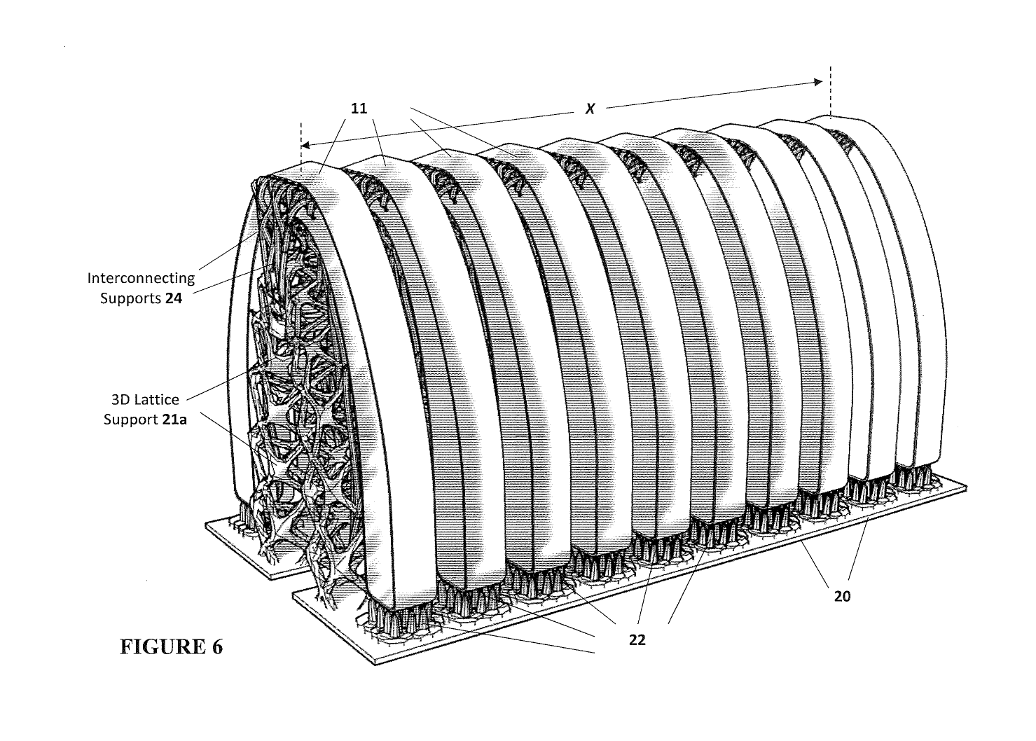

As noted above and discussed further below, FIGS. 1-3 provide various views of a first embodiment of the present invention. FIGS. 4-5 provide perspective views of additional embodiments of a three-dimensional lattice support, and FIG. 6 provides a perspective view of a plurality of objects mounted on the lattice support of FIG. 5 by interconnecting supports (not all of which are visible).

In general, as shown in FIGS. 1-3 a three-dimensional object (in this case, a dental mouth guard) 11, when produced by bottom-up stereolithography such as by CLIP, includes, in order of production, an early portion 12 and a late portion 13. Objects made by stereolithography generally include a top surface portion 14, and a bottom surface portion 15 (each of which may be flat, curved, or a complex or composite shape). The objects may include one or a plurality of generally upright segments 16, and optionally but in some embodiments preferably at least one overhanging segment 17, as in the case of the illustrated object.

In the present invention, the composite article is typically a green intermediate produced by light polymerization of a dual cure resin in an additive manufacturing process (that is, an object that has yet to undergo further cure). As noted above, The composite article typically includes: (a) optionally, but preferably, a base 20; (b) at least one three-dimensional lattice support 21 connected to the base (when present); (c) at least one three-dimensional object 11 such as described above; (d) interconnecting supports 24 connecting (i) each the at least one overhanging segment to the three-dimensional lattice and/or (ii) each at least one upright segment to the three-dimensional lattice; and (e) optionally, but in some embodiments preferably, a plurality of elongate stand-off supports 22 interconnecting the bottom surface portion of each the three-dimensional object to the base.

In some embodiments of the foregoing, the base is present (e.g., and comprises a thin planar segment, optionally but preferably configured to promote adhesion to an additive manufacturing carrier plate).

In some embodiments of the foregoing, the three-dimensional lattice support and the interconnecting supports are configured to inhibit distortion of the at least one three-dimensional object during subsequent heating of the composite article (e.g., in a subsequent heat curing step for an article formed from a dual cure resin), for example by inclusion of internal supports 23.

In some embodiments of the foregoing, the at least one three-dimensional object comprises a plurality of separate and distinct three-dimensional objects, all connected to the same the three-dimensional lattice by the interconnecting supports (the composite article preferably configured to be more rigid than a like article comprising only one three-dimensional object).

In some embodiments of the foregoing, the additive manufacturing process comprises stereolithography (e.g., bottom-up stereolithography).

In some embodiments of the foregoing, the additive manufacturing process comprises continuous liquid interface production (CLIP).

In some embodiments of the foregoing, the base is adhered to an additive manufacturing carrier plate, and optionally wherein the base has at least one resin flow opening 25 formed therein, the resin flow opening configured to promote flow of resin into the composite article during additive manufacturing thereof, and/or configured to promote flow of wash liquid into and out of the composite article during washing thereof.

In some embodiments of the foregoing, the lattice support is configured to promote flow of resin into the composite article during additive manufacturing thereof, and/or configured to promote flow of wash liquid into and out of the composite article during washing thereof. Thus in some embodiments of the foregoing, the lattice support has at least one enlarged channel 26 formed therein, the enlarged channel configured to further promote flow of resin into the composite article during additive manufacturing thereof, and/or configured to further promote flow of wash liquid into and out of the composite article during washing thereof.

Note that the embodiments of FIGS. 4-6 show an elongated lattice support 21a on which a plurality of objects 11 can be connected. Elongation of the support along at least one lateral dimension X adds additional rigidity to the composite object during both additive production, washing and handling. Note also that openings 25a and channels 26a continue to extend through the elongated lattice support.

In some embodiments of the foregoing, either: (i) the composite article is more flexible than the same article following subsequent cure (e.g., heat cure); or (ii) the composite article is less flexible than the same article following subsequent cure (e.g., heat cure) thereof).

As noted above, in some embodiments, the dual cure resin is comprised of: (i) light-polymerizable monomers and/or prepolymers that can participate in forming an intermediate object by stereolithography (preferably included in an amount of from 5, 10, or 20 percent by weight, to 50, 60, or 80 percent by weight); and (ii) heat-polymerizable monomers and/or prepolymers (preferably included in an amount of from 5, 10 or 20 percent by weight, to 40, 50 or 60 percent by weight). In some embodiments of the foregoing: (iii) the light-polymerizable monomers and/or prepolymers comprise reactive end groups selected from acrylates, methacrylates, α-olefins, N-vinyls, acrylamides, methacrylamides, styrenics, epoxides, thiols, 1,3-dienes, vinyl halides, acrylonitriles, vinyl esters, maleimides, and vinyl ethers; and/or (iv) the heat-polymerizable monomers and/or prepolymers comprise reactive end groups selected from: epoxy/amine, epoxy/hydroxyl, oxetane/amine, oxetane/alcohol, isocyanate/hydroxyl, isocyanate/amine, isocyanate/carboxylic acid, cyanate ester, anhydride/amine, amine/carboxylic acid, amine/ester, hydroxyl/carboxylic acid, hydroxyl/acid chloride, amine/acid chloride, vinyl/Si-H, Si-Cl/hydroxyl, Si-Cl/amine, hydroxyl/aldehyde, amine/aldehyde, hydroxymethyl or alkoxymethyl amide/alcohol, aminoplast, alkyne/azide, click chemistry reactive groups, alkene/sulfur, alkene/thiol, alkyne/thiol, hydroxyl/halide, isocyanate/water, Si-OH/hydroxyl, Si-OH/water, Si-OH/Si-H, Si-OH/Si-OH, perfluorovinyl, diene/dienophiles, olefin metathesis polymerization groups, olefin polymerization groups for Ziegler-Natty catalysis, and ring-opening polymerization groups, and mixtures thereof.

In some embodiments of the foregoing, the dual cure resin comprises a light-polymerizable component that degrades upon heating and forms a reactant in the heat curing thereof.

4. POST-PRODUCTION STEPS.

As noted above, a further aspect of the invention is a method of making at least one object, comprising the steps of: (a) providing a composite article as described herein; (b) optionally, but in some embodiments preferably, washing the object (e.g., with a wash liquid comprising an organic solvent); then (c) further curing the composite article (e.g., by heating); and then (d) separating each the object from the interconnecting supports, and from the stand-off supports if present, to produce the at least one object.

Washing. After the intermediate object is formed, it is optionally washed (e.g., with an organic solvent), optionally dried (e.g., air dried) and/or rinsed (in any sequence).

Solvents (or “wash liquids”) that may be used to carry out the present invention include, but are not limited to, water, organic solvents, and combinations thereof (e.g., combined as co-solvents), optionally containing additional ingredients such as surfactants, chelants (ligands), enzymes, borax, dyes or colorants, fragrances, etc., including combinations thereof. The wash liquid may be in any suitable form, such as a solution, emulsion, dispersion, etc.

Examples of organic solvents that may be used as a wash liquid, or as a constituent of a wash liquid, include, but are not limited to, alcohol, ester, dibasic ester, ketone, acid, aromatic, hydrocarbon, ether, dipolar aprotic, halogenated, and base organic solvents, including combinations thereof. Solvents may be selected based, in part, on their environmental and health, impact (see, e.g., GSK Solvent Selection Guide 2009). Additional examples include hydrofluorocarbon solvents (e.g., 1,1,1,2,3,4,4,5,5,5-decafluoropentane (Vertrel® XF, DuPont™ Chemours), 1,1,1,3,3-Pentafluoropropane, 1,1,1,3,3-Pentafluorobutane, etc.); hydrochloro-fluorocarbon solvents (e.g., 3,3 -Dichloro-1,1,1,2,2-pentafluoropropane, 1,3-Dichloro-1,1,2,2,3-pentafluoropropane, 1,1-Dichloro-1-fluoroethane, etc.); hydrofluorether solvents(e.g., methyl nonafluorobutyl ether (HFE-7100), methyl nonafluoroisobutyl ether (HFE-7100), ethyl nonafluorobutyl ether (HFE-7200), ethyl nonafluoroisobutyl ether (HFE-7200), 1,1,2,2-tetrafluoroethyl-2,2,2-trifluoroethyl ether, etc.); volatile methylsiloxane solvents (e.g., hexamethyldisiloxane (OS-10, Dow Corning), octamethyltrisiloxane (OS-20, Dow Corning), decamethyltetrasiloxane (OS-30, Dow Corning), etc.), including mixtures thereof.

Any suitable cleaning apparatus may be used, including but not limited to those described in U.S. Pat. Nos. 5,248,456; 5,482,659, 6,660,208; 6,996,245; and 8,529,703.

A preferred wash apparatus is a Carbon, Inc. smart part washer, available from Carbon, Inc., 1089 Mills Way, Redwood City, Calif. 94063 USA. Thus in a preferred embodiment, the wash step, when included, may be carried out by immersing the composite article in a wash liquid such as described above, with agitation (e.g., by rotating the composite article in the wash liquid), optionally but preferably with the wash step carried out in a total time of 10 minutes or less.

Further curing. While further (or second) curing may be carried out by any suitable technique, including but not limited to those described in U.S. Pat. No. 9,453,142. In a preferred embodiment, the further curing is carried out by heating.

Heating may be active heating (e.g., in an oven, such as an electric, gas, solar oven or microwave oven, or combination thereof), or passive heating (e.g., at ambient temperature). Active heating will generally be more rapid than passive heating and in some embodiments is preferred, but passive heating—such as simply maintaining the intermediate at ambient temperature for a sufficient time to effect further cure is in some embodiments preferred, Ovens may be batch or continuous (conveyor) ovens, as is known in the art.

Conveyor ovens are in some embodiments preferred, including multi-zone conveyor ovens and multi-heat source conveyor ovens, and associated carriers for objects that can serve to provide more uniform or regular heat to the object being cured. The design of conveyor heating ovens, and associated controls, are well known in the art. See, e.g., U.S. Pat. Nos. 4,951,648; 5,179,265; 5,197,375; and 6,799,712.

In some embodiments, the heating step is carried out at at least a first (oven) temperature and a second (oven) temperature, with the first temperature greater than ambient temperature, the second temperature greater than the first temperature, and the second temperature less than 300° C. (e.g., with ramped or step-wise increases between ambient temperature and the first temperature, and/or between the first temperature and the second temperature). In some embodiments, the heating step is carried out at at least a first (oven) temperature and a second (oven) temperature, with the first temperature greater than ambient temperature, the second temperature greater than the first temperature, and the second temperature less than 300° C. (e.g., with ramped or step-wise increases between ambient temperature and the first temperature, and/or between the first temperature and the second temperature).

For example, the intermediate may be heated in a stepwise manner at a first temperature of about 70° C. to about 150° C., and then at a second temperature of about 150° C. to 200 or 250° C., with the duration of each heating depending on the size, shape, and/or thickness of the intermediate. In another embodiment, the intermediate may be cured by a ramped heating schedule, with the temperature ramped from ambient temperature through a temperature of 70 to 150° C., and up to a final (oven) temperature of 250 or 300° C., at a change in heating rate of 0.5° C. per minute, to 5° C. per minute. (See, e.g., U.S. Pat. No. 4,785,075).

The further curing step may be carried out under conditions (e.g., time and temperature, and/or object configuration and material selection) so that it either: (i) increases the flexibility of the composite article, or (ii) decreases the flexibility of the composite article.

In some embodiments, the further curing step is carried out under conditions in which the at least one object is made less frangible than the interconnecting supports.

In some embodiments, the further curing step is carried out under conditions in which the three-dimensional lattice support is made less frangible than the interconnecting supports.

Heating is preferably carried out by directly contacting the composite article (or at least a major portion of the composite article, as the article will typically be placed on a support tray or remain adhered to a carrier platform) to a heated gas, such as heated air, in an oven such as a convection oven, rather than by surrounding the object with a support media such as salt particles and then heating the object, as previously described in X. Gu et al., cited above.

Further post-processing. Once the further curing step is completed, any routine post-processing steps (further cleaning, cutting, grinding, etc.) can be performed, and the object packaged or assembled with other components for delivery or for its intended use.

The foregoing is illustrative of the present invention, and is not to be construed as limiting thereof. The invention is defined by the following claims, with equivalents of the claims to be included therein.

1. A composite article useful in additive manufacturing, the composite article comprising:
(a) an optional base;
(b) at least one three-dimensional lattice support connected to said base (when present);
(c) at least one three-dimensional object, the object having a bottom surface portion, a top surface portion, at least one upright segment, and optionally at least one overhanging segment;
(d) interconnecting supports connecting (i) each said at least one overhanging segment to said three-dimensional lattice and/or (ii) each at least one upright segment to said three-dimensional lattice; and
(e) optionally, a plurality of elongate stand-off supports interconnecting said bottom surface portion of each said three-dimensional object to said base;
wherein said composite article is a green intermediate produced by light polymerization of a dual cure resin in an additive manufacturing process.

2. The composite article of claim 1, wherein said base is present, and comprises a thin planar segment, optionally configured to promote adhesion of the composite article to an additive manufacturing carrier plate.

3. The composite article of claim 1, wherein said stand-off supports are present.

4. The composite article of claim 1, wherein said three-dimensional lattice support and said interconnecting supports are configured to inhibit distortion of said at least one three-dimensional object during subsequent heating of said composite article.

5. The composite article of claim 1, wherein said at least one three-dimensional object comprises a plurality of separate and distinct three-dimensional objects, all connected to the same said three-dimensional lattice by said interconnecting supports.

6. The composite article of claim 1, wherein said additive manufacturing process comprises stereolithography.

7. The composite article of claim 1, wherein said additive manufacturing process comprises continuous liquid interface production.

8. The composite article of claim 1, wherein said base is adhered to an additive manufacturing carrier plate, and optionally wherein said base has at least one resin flow opening formed therein, said resin flow opening configured to promote flow of resin into said composite article during additive manufacturing thereof, and/or configured to promote flow of wash liquid into and out of said composite article during washing thereof.

9. The composite article of claim 1, wherein said lattice support is configured to promote flow of resin into said composite article during additive manufacturing thereof, and/or configured to promote flow of wash liquid into and out of said composite article during washing thereof.

10. The composite article of claim 1, wherein said lattice support has at least one enlarged channel formed therein, said enlarged channel configured to further promote flow of resin into said composite article during additive manufacturing thereof, and/or configured to further promote flow of wash liquid into and out of said composite article during washing thereof.

11. The composite article of claim 1, wherein:
(i) said composite article is more flexible than the same article following subsequent cure; or
(ii) said composite article is less flexible than the same article following subsequent cure thereof.

12. The composite article of claim 1, wherein said dual cure resin is comprised of:
(i) light-polymerizable monomers and/or prepolymers that can participate in forming an intermediate object by stereolithography included in an amount of from 5 percent by weight to 80 percent by weight;
(ii) heat-polymerizable monomers and/or prepolymers included in an amount of from 5 percent by weight to 60 percent by weight.

13. The article of claim 12, wherein:
(iii) said light-polymerizable monomers and/or prepolymers comprise reactive end groups selected from acrylates, methacrylates, α-olefins, N-vinyls, acrylamides, methacrylamides, styrenics, epoxides, thiols, 1,3-dienes, vinyl halides, acrylonitriles, vinyl esters, maleimides, and vinyl ethers; and/or
(iv) said heat-polymerizable monomers and/or prepolymers comprise reactive end groups selected from: epoxy/amine, epoxy/hydroxyl, oxetane/amine, oxetane/alcohol, isocyanate/hydroxyl, isocyanate/amine, isocyanate/carboxylic acid, cyanate ester, anhydride/amine, amine/carboxylic acid, amine/ester, hydroxyl/carboxylic acid, hydroxyl/acid chloride, amine/acid chloride, vinyl/Si-H, Si-Cl/hydroxyl, hydroxyl/aldehyde, amine/aldehyde, hydroxymethyl or alkoxymethyl amide/alcohol, aminoplast, alkyne/azide, click chemistry reactive groups, alkene/sulfur, alkene/thiol, alkyne/thiol, hydroxyl/halide, isocyanate/water, Si-OH/hydroxyl, Si-OH/water, Si-OH/Si-H, Si-OH/Si-OH, perfluorovinyl, diene/dienophiles, olefin metathesis polymerization groups, olefin polymerization groups for Ziegler-Natta catalysis, and ring-opening polymerization groups, and mixtures thereof.

14. The composite article of claim 1, wherein said dual cure resin comprises a light-polymerizable component that degrades upon heating and forms a reactant in heat curing, thereof.

15. A method of making at least one object, comprising the steps of:
(a) providing a composite article, the composite article comprising:
(i) an optional base;
(ii) at least one three-dimensional lattice support connected to said base (when present);
(iii) at least one three-dimensional object, the object having a bottom surface portion, a top surface portion, at least one upright segment, and optionally at least one overhanging segment;
(iv) interconnecting supports connecting (i) each said at least one overhanging segment to said three-dimensional lattice and/or (ii) each at least one upright segment to said three-dimensional lattice; and
(v) optionally, a plurality of elongate stand-off supports interconnecting said bottom surface portion of each said three-dimensional object to said base;
wherein said composite article is a green intermediate produced by light polymerization of a dual cure resin in an additive manufacturing process;
(b) optionally washing said object; then
(c) further curing said composite article; and then
(d) separating each said object from said interconnecting supports, and from said stand-off supports if present, to produce said at least one object.

16. The method of claim 15, wherein said further curing step is carried out by heating.

17. The method of claim 15, wherein said wash step is included and is carried out by immersing said composite article in a wash liquid, with agitation, optionally wherein said wash step is carried out in a time of 10 minutes or less.

18. The method of claim 15, wherein said further curing step either:
(i) increases the flexibility of said composite article, or
(ii) decreases the flexibility of said composite article.

19. The method of claim 15, wherein said further curing step is carried out under conditions in which said least one object is made less frangible than said interconnecting supports.

20. The method of claim 15, wherein said further curing step is carried out under conditions in which said three-dimensional lattice support is made less frangible than said interconnecting supports.
